(19) United States
(12) Patent Application Publication
(10) Pub. No.: US 2009/0291363 A1
(43) Pub. Date: Nov. 26, 2009

(54) BATTERY COVER MECHANISM

(75) Inventors: SHU-FENG ZHANG, Shenzhen City (CN); YUNG-CHANG YEN, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/466,477

(22) Filed: May 15, 2009

(30) Foreign Application Priority Data
May 21, 2008 (CN) 200810301704.7

(51) Int. Cl. H01M 2/04

(52) U.S. Cl. 429/163

(57) ABSTRACT

A battery cover mechanism used in a portable electronic device includes a housing defining a receiving groove therein for receiving a battery, a cover mounted an elastic member, the elastic member defines a locking space, the housing has a protrusion formed thereon, the protrusion is latched with the locking space to latch the cover with the housing.

### BACKGROUND

1. Field of the Invention

The present invention relates to battery cover mechanisms, particularly to a battery cover mechanism used in portable electronic devices.

2. Description of Related Art

Portable electronic devices such as mobile phones and personal digital assistants (PDAs) are widely used. When a battery is installed in the portable electronic device, the battery is generally shielded and fixed in place by a battery cover mechanism.

A typical battery cover mechanism includes a cover and a housing. The cover includes a pin at on one end and a hook at an opposite end. The housing defines a receiving hole and a holding aperture. The hook can be inserted into the holding aperture, and the cover can be pressed towards the housing until the pin is received into the receiving hole. As such, the cover securely engages with the housing by the hooking of the hook. However, the pin tends to slide out of the receiving hole when exerting a large external force.

Therefore, there is room for improvement within the art.

### BRIEF DESCRIPTION OF THE DRAWINGS

Many aspects of the present battery cover mechanism can be better understood with reference to the following drawings. The components in the various drawings are not necessarily drawn to scale, the emphasis instead being placed upon clearly illustrating the principles of the present battery cover mechanism. Moreover, in the drawings, like reference numerals designate corresponding parts throughout the diagrams.

FIG. 1 is a disassembled view of the battery cover mechanism, according to an exemplary embodiment.

FIG. 2 is an assembled view of the battery cover shown in FIG. 1.

FIG. 3 is an assembled view of the battery cover mechanism shown in FIG. 1.

### DETAILED DESCRIPTION OF THE EMBODIMENT

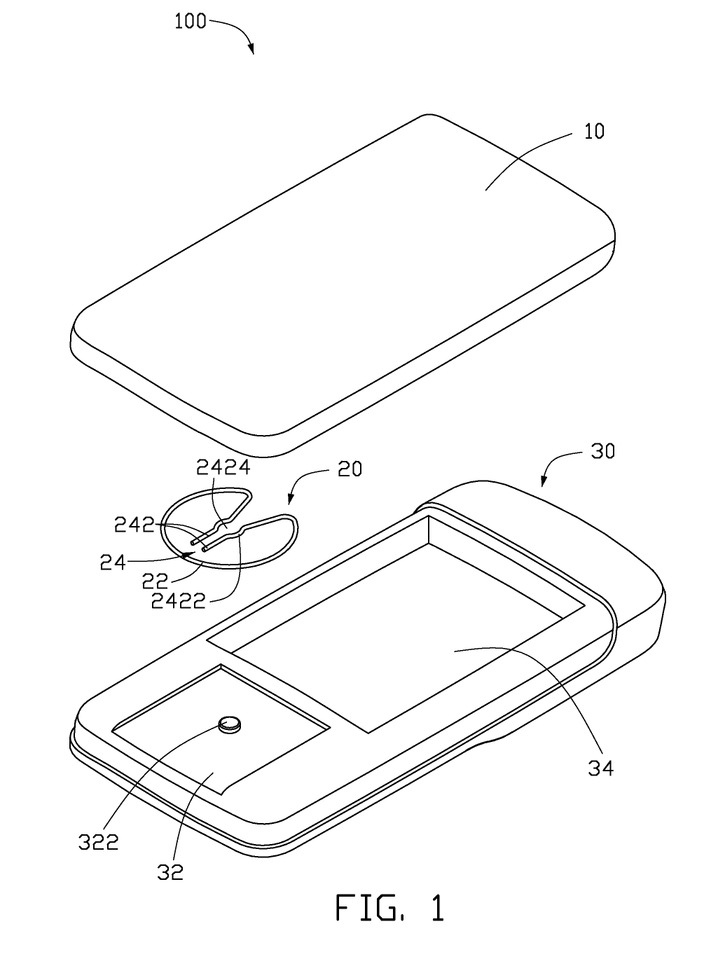

Referring to FIG. 1, the battery cover mechanism 100 can be used in mobile phones, and can also used in other portable electronic devices, such as personal digital assistants (PDAs), digital cameras, etc. The battery cover mechanism 100 includes a cover 10, an elastic member 20, and a housing 30.

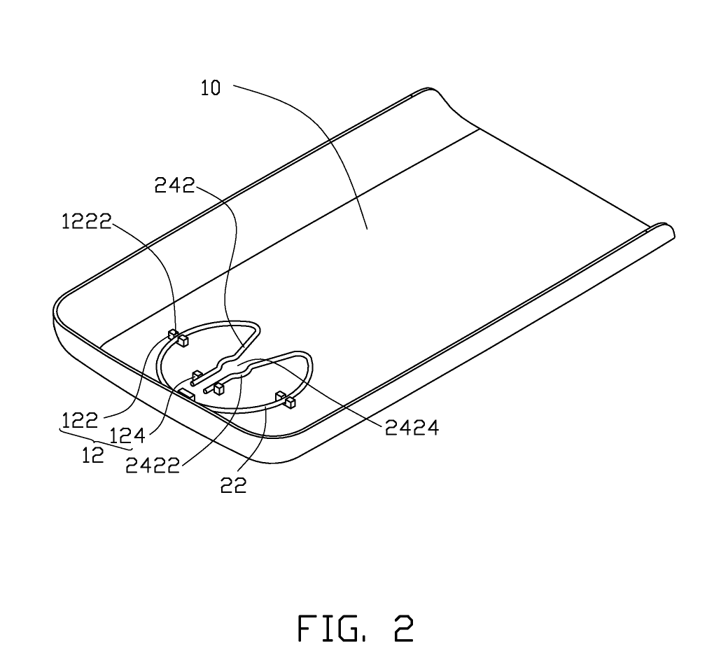

Referring FIG. 2, the cover 10 has a plurality of locking members 12 protruding from its interior surface and configured for holding or locking the elastic member 20 in place. The locking member 12 includes a plurality of first locking members 122 and a plurality of second locking members 124, e.g., three first rectangular locking members 122 and two second rectangular locking members 124. Each of the first locking members 122 has a locking recess 1222 defined, and the locking recess 1222 is configured for securing the elastic 20. The two second locking members 124 are parallel and between the first locking members 122.

The elastic member 20 includes a fixing portion 22 and a locking portion 24 integrally formed with the fixing portion 22. The fixing portion 22 is generally circular and configured for engaging with the first locking member 12. The locking portion 24 includes two bending strips 242 bending toward the center of the circle, symmetrically about the diameter of the circle and approaching each other. Each of the bending strips 242 includes an arc section 2422 at the middle thereof, the two arc sections 2422 face each other to define a locking space 2424 therebetween.

The housing 30 has an assembling groove 32 and a receiving groove 34 defined. The assembling groove 32 is defined at an end of the housing 30, and the assembling groove 32 has a protrusion 322 protruding near the center. The protrusion 322 is a column to securely engage into the locking space 2424 of the elastic member 20. The receiving groove 34 is defined near the assembling groove 32 and configured for receiving a battery (not shown).

In assembling of the cover 10, the elastic member 20 latched with the locking member 12, the fixing portion 22 can be received the locking recesses 1222 of the first locking members 122, the locking portion 24 can be positioned between the two second locking member 124 by the two bending strips 242 resisting the two second locking member 124 respectively.

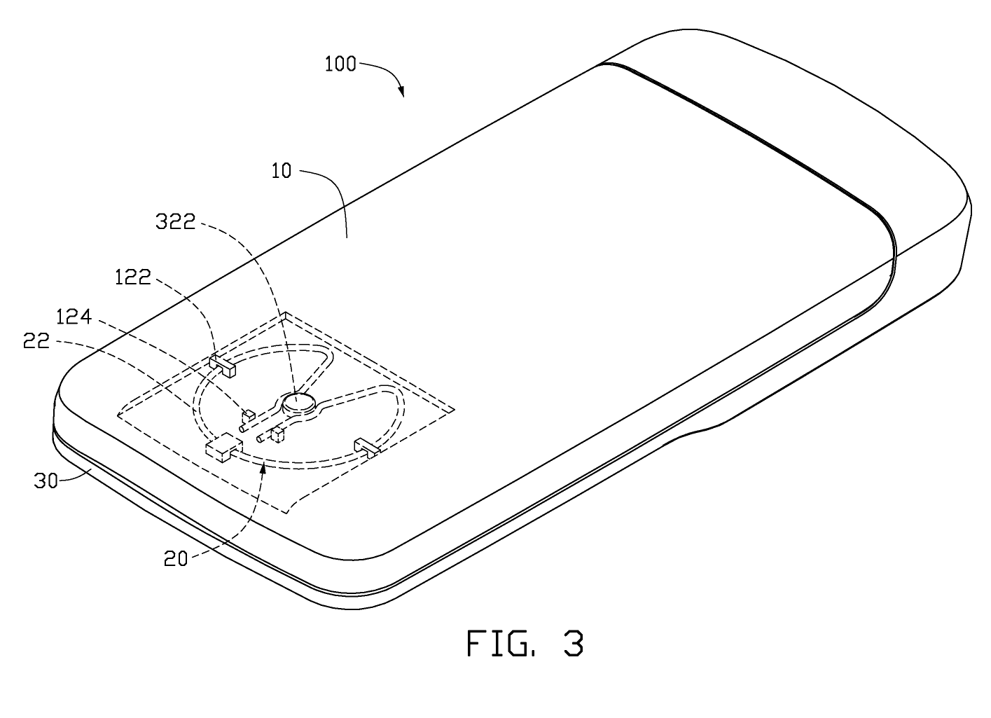

Referring to FIG. 3, to latch the cover 10 to the housing 30, one end of the cover 10 is placed at one end of the housing 30. The cover 10 can slide relative to the housing 30, as such, the protrusion 322 of the housing 30 engages into the locking space 2424. Therefore, the cover 10 and the housing 30 firmly latch with each other. For removing the cover 10 from the housing 30, the cover 10 can be pushed reversely to drive the protrusion 322 to overcome the securing of the locking portion 24 and apart therefrom.

In the exemplary battery cover mechanism 100, the cover 10 can be installed on the housing 30 through tightly securing of the locking portion 24 with the protrusion 322.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery cover mechanism for a portable electronic device, comprising:
a housing having a protrusion protruding therefrom;
a cover; and
an elastic member fixed to the cover, the elastic member defining a locking space, the protrusion latched within the locking space to latch the cover to the housing.

2. The battery cover mechanism as claimed in claim 1, wherein elastic member includes a fixing portion and a locking portion integrally formed with the fixing portion, the fixing portion is fixed to the cover, the locking portion defines the locking space.

3. The battery cover mechanism as claimed in claim 1, wherein the fixing portion is circle, the locking portion includes bending strips, the bending strips connect two ends of the fixing portion respectively and bend toward the center of the circle.

4. The battery cover mechanism as claimed in claim 3, wherein each of the bending strips includes an arc section at the middle of the bending strips, the two arc sections face each other to define the locking space.

5. The battery cover mechanism as claimed in claim 1, wherein the cover includes a plurality of locking members protruding on its interior surface and are configured for locking the elastic member.

6. The battery cover mechanism as claimed in claim 5, wherein the locking members include a plurality of first locking members, each of first locking members defines a locking recess for engaging with the fixing portion.

7. The battery cover mechanism as claimed in claim 5, wherein the housing includes a plurality of second locking members, the second locking members are configured for resisting the elastic member.

8. The battery cover mechanism as claimed in claim 1, wherein the housing defines an assembling groove, the protrusion is protruding in the assembling groove.

9. A battery cover mechanism used in a portable electronic device, comprising:
a housing defining a receiving groove therein for receiving a battery;
a cover corresponding to the housing;
an elastic member mounted on the cover;
wherein the elastic member includes a fixing portion and a locking portion integrally formed with the fixing portion, the fixing portion is secured to the cover, the locking portion defines a locking space, the housing forms a protrusion, the protrusion latches with the locking space to latch the cover with the housing.

10. The battery cover mechanism as claimed in claim 9, wherein the cover forms a plurality of first locking members, the elastic member includes a fixing portion, the first locking members engage with the fixing portion.

11. The battery cover mechanism as claimed in claim 9, wherein the cover forms a plurality of second locking members, the locking portion includes two bending strips, the bending strips resist the second locking respectively.

12. The battery cover mechanism as claimed in claim 11, wherein the two bending strips are bending toward the center of a circle, symmetrically about the diameter of the circle and approaching each other.

13. The battery cover mechanism as claimed in claim 12, wherein each of the bending strips includes an arc section, the two arc sections face each other to define the locking space.
